(19) United States
(12) Patent Application Publication
(10) Pub. No.: US 2009/0021944 A1
(43) Pub. Date: Jan. 22, 2009

(54) LED LAMP

(75) Inventors: TSUNG-LUNG LEE, Tu-Cheng (TW); LI HE, Shenzhen (CN); XU-HUA XIAO, Shenzhen (CN); YI-SAN LIU, Shenzhen (CN); WEN-XIANG ZHANG, Shenzhen (CN); GUANG YU, Shenzhen (CN); SHI-SONG ZHENG, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 11/833,948

(22) Filed: Aug. 3, 2007

(30) Foreign Application Priority Data
Jul. 18, 2007 (CN) 200710075206.0

(51) Int. Cl. F21V 29/00

(52) U.S. Cl. 362/294

(57) ABSTRACT

An LED lamp includes a bulb, an LED module having a plurality of LEDs received in the bulb and a heat dissipation apparatus supporting and cooling the LED module. The heat dissipation device includes a heat sink, a hollow first heat conductor, and a heat pipe. The heat sink has a hollow base and a plurality of fins mounted on the base. The hollow first heat conductor is supported by the heat sink. The heat pipe is retained in the heat sink and the first heat conductor in such a manner that an outer periphery surface of the heat pipe is tightly enclosed by the base and the first heat conductor. The LEDs are distributed on the first heat conductor.

### CROSS REFERENCE

Relevant subject matter is disclosed in a pending U.S. patent application Ser. No. 11/769,658, filed on Jun. 27, 2007, entitled “LED LAMP” and invented by Tsung-Lung Lee, Xu-Hua Xiao and Li He, which is assigned to the same assignee as this application and incorporated herein by reference.

### BACKGROUND OF THE INVENTION

1. Field of the Invention

The present invention relates to an LED lamp, and particularly to an LED lamp having a heat dissipation apparatus for heat dissipation.

2. Description of Related Art

An LED lamp is a type of solid state lighting that utilizes light-emitting diodes (LEDs) as a source of illumination. An LED is a device for transferring electricity to light by using a theory that, if a current is made to flow in a forward direction in a junction comprising two different semiconductors, electrons and holes are coupled at a junction region to generate a light beam. The LED has an advantage in that it is resistant to shock, and has an almost eternal lifetime under a specific condition; thus, the LED lamp is intended to be a cost-effective yet high quality replacement for incandescent and fluorescent lamps.

An LED lamp generally requires a plurality of LEDs, and most of the LEDs are driven at the same time, which results in a quick rise in temperature of the LED lamp. Since generally the LED lamps do not have heat dissipation devices with good heat dissipating efficiencies, operation of the general LED lamps has a problem of instability because of the rapid build up of heat. Consequently, the light from the LED lamp often flickers, which degrades the quality of the illumination. Furthermore, the LED lamp is used in a high heat state for a long time and the life time thereof is consequently shortened.

What is needed, therefore, is an LED lamp which has a greater heat-dissipation capability.

### SUMMARY OF THE INVENTION

An LED lamp comprises a bulb, an LED module comprising a plurality of LEDs received in the bulb and a heat dissipation apparatus supporting and cooling the LED module. The heat dissipation device comprises a heat sink, a hollow first heat conductor, and a heat pipe (or a vapor chamber). The heat sink has a hollow base and a plurality of fins mounted on the base. The hollow first heat conductor is supported by the heat sink. The heat pipe is retained in the heat sink and the first heat conductor in such a manner that an outer periphery surface of the heat pipe is tightly enclosed by the base and the first heat conductor. The LEDs are distributed on the first heat conductor.

### BRIEF DESCRIPTION OF THE DRAWINGS

Many aspects of the present LED lamp can be better understood with reference to the following drawings. The components in the drawings are not necessarily drawn to scale, the emphasis instead being placed upon clearly illustrating the principles of the present LED lamp. Moreover, in the drawings, like reference numerals designate corresponding parts throughout the several views.

FIG. 1 is an isometric view of an LED lamp in accordance with a preferred embodiment of the present invention, wherein LEDs thereof are shown in dotted lines;

FIG. 2 is similar to FIG. 1, with a bulb and a reflector of the LED lamp of FIG. 1 being removed away;

FIG. 3 is an exploded, isometric view of FIG. 2;

FIG. 4 is a cross sectional view of FIG. 2; and

FIG. 5 is an isometric view of a heat dissipation apparatus of an LED lamp in accordance with another preferred embodiment of the present invention.

### DETAILED DESCRIPTION OF THE INVENTION

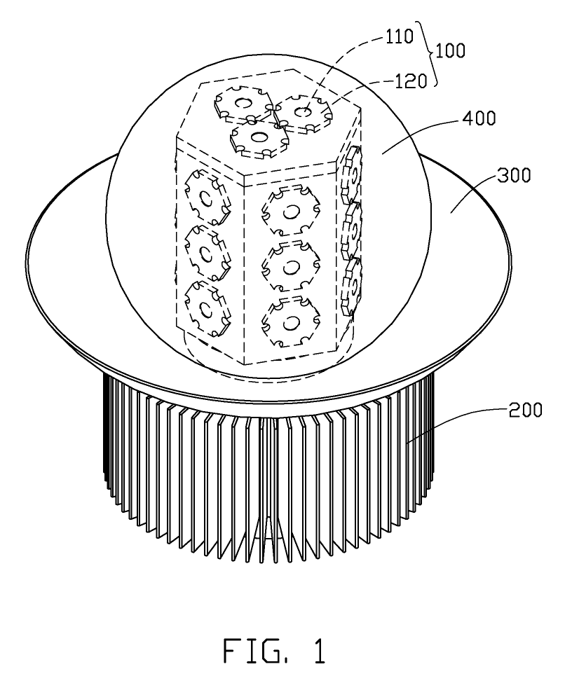

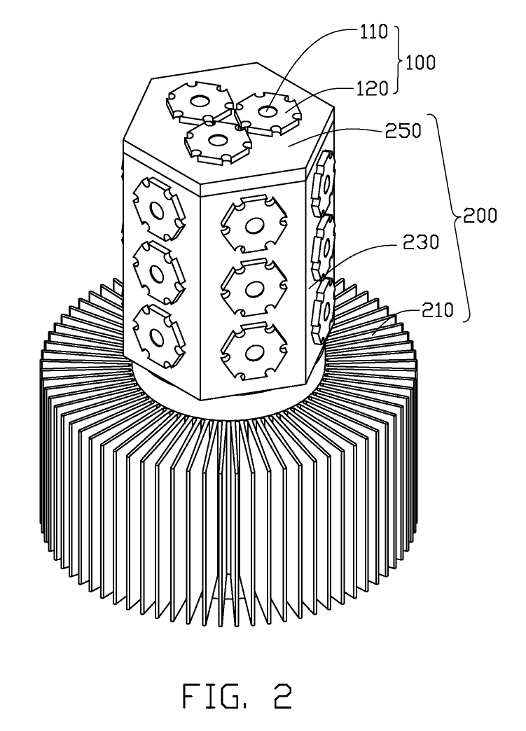

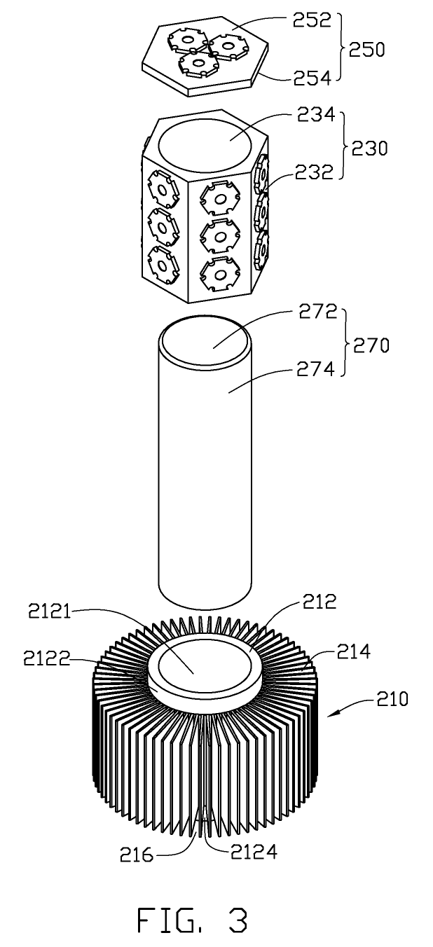

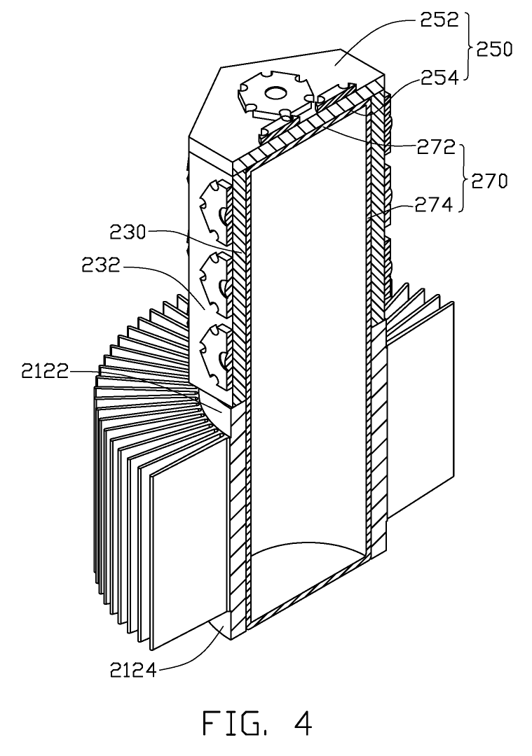

Referring to FIGS. 1-4, an LED lamp of a preferred embodiment of the invention comprises an LED module 100, a heat dissipation apparatus 200 for supporting and cooling the LED module 100, a reflector 300 mounted on the heat dissipation apparatus 200, and a bulb 400 attached to the reflector 300 and enclosing the LED module 100.

The reflector 300 is a bowl-shaped construction having a concave upper surface (not labeled) and a hole (not visible) defined in a central portion of the reflector 300. The reflector 300 is used to reflect the light emitted from the LED module 100 upwardly. If desired, the reflector 300 may be omitted, and the bulb 400 may be directly attached to the heat dissipation apparatus 200.

The bulb 400 has an inner space (not labeled) for receiving the LED module 100 therein. The bulb 400 is generally made of transparent plastic, glass, or other suitable material. The bulb 400 is fitted over the reflector 300 for enabling the light emitted from the LED module 100 to pass through the bulb 400, while preventing dust, insect or the like from entering the bulb 400 to affect the service life of the LED module 100.

The LED module 100 generally comprises a plurality of LEDs 110 each mounted on a printed circuit board 120. The LEDs 110 are installed into the corresponding printed circuit boards 120 and electrically connected to the circuits (not shown) provide on the printed circuit boards 120. The printed circuit boards 120 are further electrically connected to a power (not shown) through wires (not shown).

The heat dissipation apparatus 200 comprises a heat sink 210, a first heat conductor 230 vertically positioned above the heat sink 210, a second heat conductor 250 horizontally mounted on the first heat conductor 230, and a heat pipe or vapor chamber 270 thermally connecting the second heat conductor 250, the first heat conductor 230 and the heat sink 210 in series. The heat pipe or vapor chamber 270 is heat transfer device, which has a container defining a vacuum inner space. The vacuum inner space receives a phase-changeable fluid therein. The fluid becomes vapor when heated and becomes liquid when cooled and can circulate in the container.

The heat sink 210 has a cylindrical configuration, and comprises a cylindrical base 212 and a plurality of fins 214. The fins 214 extend radially and outwardly from an outer periphery of the base 212. A plurality of channels 216 is defined between adjacent fins 214 for an airflow flowing therethrough. The base 212 is hollow and has a through hole 2121 defined therethrough. The base 212 has a top end portion 2122 above a top surface of the fins 214, and a bottom end portion 2124 below a bottom surface of the fins 214. The top end portion 2122 is extended through the though hole (not shown) of the reflector 300 into the inner space (not labeled) of the bulb 400, and the bottom end portion 2124 is connected to a lamp base (not shown), such as a supporting stand.

The heat pipe 270 is partly inserted into the through hole 2121 of the base 212. The heat pipe 270 is in straight configuration, and comprises a top surface 272 abutting against a bottom surface 254 of the second heat conductor 250. An outer peripheral surface 274 of the heat pipe 270 is enclosed by the heat sink 210 and the first heat conductor 230. More particularly, an outer periphery surface of a lower part of the heat pipe 270 is tightly enclosed by an inner surface of the cylindrical base 212 of the heat sink 210. An outer periphery surface of an upper part of the heat pipe 270 is tightly enclosed by the first heat conductor 230.

The first heat conductor 230 is supported by and mounted on the heat sink 210. The first heat conductor 230 has a hexagonal configuration with six side surfaces 232. On each side surface 232 of the first heat conductor 230, there are three LEDs 110 arranged in a line parallel to an axial direction of the first heat conductor 230. The first heat conductor 230 is a hollow structure, and has a through hole 234 defined therethrough. The through hole 234 of the first heat conductor 230 is provided to receive and retain the upper part of the heat pipe 270; as a result, the outer periphery surface of the upper part of the heat pipe 270 is tightly enclosed by an inner surface of the first heat conductor 230 defining the through hole 234.

In other words, the heat pipe 270 is installed and retained in the through hole 234 of the first heat conductor 230 and the through hole 2121 of the heat sink 210 with the top surface 272 of the heat pipe 270 covered by the second heat conductor 250.

The second heat conductor 250 has a hexagonal plate-like structure. The second heat conductor 250 comprises a top surface 252 supporting three LEDs 110 thereon. The bottom surface 254 is attached to a top surface of the first heat conductor 230 and the top surface 272 of the heat pipe 270.

The heat pipe 270, the first heat conductor 230, the second heat conductor 250 and the heat sink 210 can be connected together to form the heat dissipation apparatus 200 via soldering, welding or other method. Then, the LEDs 110 with printed circuit boards 120 can be positioned on the top surface 252 of the second heat conductor 250 and the side surfaces 232 of the first heat conductor 230, respectively. The LEDs 110 on the top side 252 of the second heat conductor 250 are oriented toward a direction which is perpendicular to that of the LEDs 110 on the side surfaces 232 of the first heat conductor 230. Thus, a three-dimensional light source is formed to increase illumination effect of the LED lamp.

The three-dimensional light source, including the first and second heat conductors 230, 250 and the LED module 100 are extended though the through hole of the reflector 300 and retained in the bulb 400 to thereby form the LED lamp.

In operation, when the LEDs 110 are powered to produce light, heat produced by the LEDs 110 are first absorbed by the first and second heat conductors 230, 250. Then, the heat accumulated at the first and second heat conductors 230, 250 heats up and evaporates working fluid (not shown) contained in the heat pipe 270. Sequentially, the evaporated working fluid flows towards the heat sink 210, conveys carried heat to the base 212 of the heat sink 210 and returns to liquid state. Finally, the heat at the base 212 is dissipated to surrounding environment via the fins 214. Thus, the heat produced by the LEDs 110 can be quickly transferred away via the heat pipe 270, and quickly dissipated via the heat sink 210. Therefore, the heat of the LEDs 110 is quickly removed away, and the LED lamp can work within an acceptable temperature range.

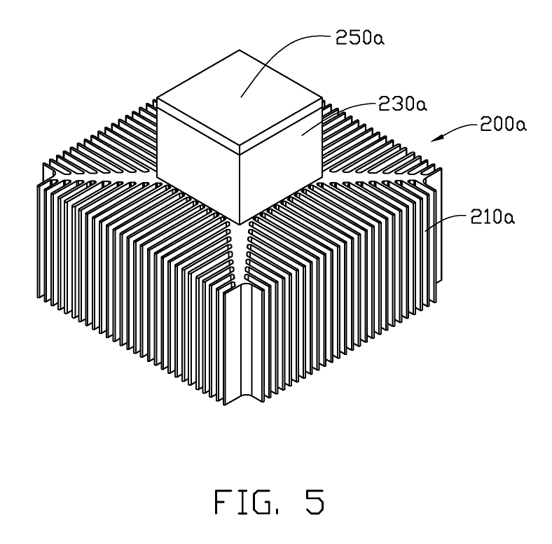

FIG. 5 illustrates a heat dissipation apparatus 200a of an LED lamp of another preferred embodiment of the invention. The heat dissipation apparatus 200a is similar to the heat dissipation apparatus 200, and it also includes a hollow heat sink 210a, a hollow first heat conductor 230a positioned above the heat sink 210a, a second heat conductor 250a mounted on the first heat conductor 230, and a heat pipe or vapor chamber (not shown). The heat pipe is retained in the heat sink 210a and the first heat conductor 230a in a similar manner as described above in connection with the first embodiment. The main difference between the heat dissipation apparatus 200a and the heat dissipation apparatus 200 is that the heat sink 210a is in a form of about a rectangular block, and the first and second heat conductors 230a, 250a together form a rectangular parallelepiped.

It is can be understood that the LEDs 110, which are positioned at a common surface, such as one side surface 232 of the first heat conductor 230, the top surface 252 of the second heat conductor 250, may be arranged to electrically connect to one printed circuit board.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An LED lamp comprising:
a bulb;
an LED module comprising a plurality of LEDs received in the bulb;
a heat dissipation apparatus supporting and cooling the LED module, the heat dissipation device comprising:
a heat sink having a hollow base and a plurality of fins mounted on the base;
a hollow first heat conductor supported by the heat sink; and
a heat transfer device having a container defining a vacuum space receiving a phase-changeable working fluid therein, being retained in the heat sink and the first heat conductor in such a manner that an outer periphery surface of the heat transfer device is tightly enclosed by the base and the first heat conductor;
wherein the LEDs are distributed on the first heat conductor.

2. The LED lamp as described in claim 1, wherein the heat dissipation device further comprises a second heat conductor mounted on the first heat conductor, and a top surface of the heat transfer device is attached to the second heat conductor.

3. The LED lamp as described in claim 2, wherein the base has an upper end portion extending above the fins, and the upper end portion extends into the bulb.

4. The LED lamp as described in claim 3, wherein the first heat conductor is mounted on the upper end portion.

5. The LED lamp as described in claim 4, wherein the base has a lower end portion extending below the fins, and the lower end portion is adapted for connection with a supporting stand.

6. The LED lamp as described in claim 5, wherein the upper and lower end portions are located at different sides of the heat sink.

7. The LED lamp as described in claim 2, wherein the LEDs are distributed on the first heat conductor and the second heat conductor.

8. The LED lamp as described in claim 1, wherein the fins extend radially and outwardly from an outer periphery surface of the hollow base.

9. The LED lamp as described in claim 8, wherein the heat sink has a cylindrical configuration.

10. The LED lamp as described in claim 8, wherein the heat sink is in form of a rectangular block.

11. The LED lamp as described in claim 1, wherein the first heat conductor has a plurality of side surfaces, and each side surface has a plurality of LEDs arranged thereon.

12. The LED lamp as described in claim 1, further comprising a reflector mounted on the heat sink, and the bulb is attached to the bulb.

13. The LED lamp as described in claim 1, further comprising at least one printed circuit board, and the LEDs are electrically connected to the at least one printed circuit board.

14. The LED lamp as described in claim 1, wherein the heat transfer device is one of a heat pipe and a vapor chamber.

15. An LED lamp comprising:
a heat sink having a plurality of fins thereon;
a heat transfer device which has a container defining a vacuum space receiving a phase-changeable working fluid therein, having a lower portion being thermally connected to the heat sink and an upper portion;
a heat conductor being thermally connected to the upper portion of the heat transfer device; and
an LED module having a plurality of LEDs being mounted on the heat conductor.

16. The LED lamp as described in claim 15, wherein the heat transfer device is one of a heat pipe and a vapor chamber.

17. The LED lamp as described in claim 16, wherein the heat transfer device has a cylindrical configuration, and a circumferential periphery of the heat transfer device is tightly enclosed by the heat sink and the heat conductor.

18. The LED lamp as described in claim 17, wherein the heat conductor has a polygonal configuration with a plurality of side faces, and the LEDs of the LED module are attached on the side faces, respectively.
